(19) United States
(12) Patent Application Publication
(10) Pub. No.: US 2013/0271482 A1
(43) Pub. Date: Oct. 17, 2013

(54) ELECTRONIC MAP GENERATION

(71) Applicant: LIVING MAP LIMITED, London (GB)

(72) Inventor: Timothy Brian Fendley, Bathford Bath (GB)

(73) Assignee: Living Map Limited, London (GB)

(21) Appl. No.: 13/861,944

(22) Filed: Apr. 12, 2013

(30) Foreign Application Priority Data
Apr. 17, 2012 (GB) 1206752.6

(51) Int. Cl. G06T 11/20

(52) U.S. Cl. CPC G06T 11/206
USPC 345/589; 345/440

(57) ABSTRACT

A map or plan of a location is generated from a set of map data, wherein at least some of said map data has a time-dependent status associated therewith. An input time is determined from a user input and said map data is displayed according to its associated time-dependent status on the basis of said input time. When the input time is changed, the map data displayed is changed accordingly.

This invention relates to the generation of maps electronically, particularly although not exclusively, to the electronic generation of maps on demand e.g. on a portable electronic device.

The use of maps in handheld mobile devices, e.g. smart phones, is very popular since it allows the GPS capability of such devices to be exploited for a user's convenience. One of the issues which a developer of a map application must decide is the type of information and level of detail that should be displayed on a map to make it useful and informative for the user whilst not being too cluttered. This is of course a more significant concern for handheld devices which tend to have relatively small display screens. It means that there are many different types of map possible covering the same area but showing different features and information depending upon what the user is most interested in.

The present invention aims to provide a convenient way of emphasising the information which is of most relevance to a user and when viewed from a first aspect provides a method of generating a map or plan of a location from a set of map data, wherein at least some of said map data has a time-dependent status associated therewith, the method comprising:
determining an input time from a user input;
displaying said map data according to its associated time-dependent status on the basis of said input time; and
when the input time is changed, changing the map data displayed accordingly.

The invention extends to an apparatus for generating a map or plan of a location from a set of map data, wherein at least some of said map data has a time-dependent status associated therewith, the apparatus being configured to:
determine an input time from a user input; and
display said map data according to its associated time-dependent status on the basis of said input time; wherein the apparatus is further configured such that when the input time is changed, the map data displayed is changed accordingly.

The invention also extends to computer software, whether or not on a carrier, adapted when run on a computing device to generate a map or plan of a location from a set of map data, wherein at least some of said map data has a time-dependent status associated therewith, the software comprising:
logic for determining an input time from a user input; and
logic for displaying said map data according to its associated time-dependent status on the basis of said input time;
   wherein the software is configured such that when the input time is changed, the map data displayed is changed accordingly.

The invention also extends to a non-transitory computer-readable medium having stored thereon instructions executable by a processor to generate a map or plan of a location from a set of map data, wherein at least some of said map data has a time-dependent status associated therewith, the instructions comprising:
determining an input time from a user input; and
displaying said map data according to its associated time-dependent status on the basis of said input time;
   wherein when the input time is changed, the map data displayed is changed accordingly.

Thus it will be seen by those skilled in the art that in accordance with the invention, a user can specify a particular time in which he or she is interested in the location for which the map is to be generated, and any map data which has an associated time-dependent status will be displayed according to its status at the time chosen by the user. Resultant maps can be delivered in a visually edited and pleasing design in keeping with the original user input. In a set of embodiments for example the time-dependent status comprises whether a building, service or facility is open or closed. This allows a user to specify the time at which he or she expects to be at a location and the user will then be shown which shops, bars, museums, galleries etc. are open at the specified time. In other embodiments other time-sensitive statuses can be indicated—e.g. to show availability.

This provides a simple, intuitive way for a user to determine what facilities and services are available without having to check individually with each one. Moreover, rather than being restricted to a fixed time, e.g. real time or an arrival time, the ability to be able to alter the input time allows the user quickly and easily to see the effect this has on status of the services and facilities available—e.g. which are open and closed—and therefore opens up the opportunity for the user to adapt their plans to suit the availability of particular services or facilities.

In one set of embodiments, map data having a predetermined time-dependent status—e.g. that a building is closed—are simply omitted from the map. In other words the time-dependent status is indicated by displaying or not displaying the data. This potentially has benefits in keeping the map uncluttered by showing only the data of relevance.

In another set of embodiments, all map data is displayed and the time-dependent status is indicated another way. This could, for example, be done by displaying the data in a different colour depending on its status: closed buildings might appear “greyed out” and/or open buildings highlighted relative to closed ones. In another possibility, the map may show a representation of a building or place where the service which is not available at the input time, is provided, but without labelling it. Indeed any combination of these things might be used. More simplistically a label or other text could be used to indicate the status which corresponds to the input time.

The user input could take any of a number of possible forms depending up on the particular application. It could, for example, comprise a simple keyboard input of the required input time, or it could comprise a drop-down menu or a set numerical scroll-wheels used to set the particular time. In a preferred set of embodiments, however, the user input comprises a graphical user interface (GUI) element having a plurality of positions corresponding to different times whereby the user can manipulate the GUI element to different positions to select the required time. For example, the GUI element could be a wheel, clock face or slider which the user can move to alter the input time. This provides a simple and intuitive way to enter the time and, in particular, observe the impact which this has on the displayed map. Where the invention is implemented using a touchscreen device, it allows the user to change the input time simply by swiping a finger along the slider or around the wheel etc. In a preferred set of embodiments, an indication of the time selected by the user is given.

The range of time which can be selected by the user may be determined depending on the application, although in a set of preferred embodiments the user can alter the time through a 24 hour range so that the displayed map is dependent upon the daily statuses of particular services, facilities etc.

Preferably the input time selected is displayed.

In a preferred set of embodiments, the generated map is displayed on the screen of a mobile device. The map could be generated locally by the mobile device by receiving the full set of map data from a remote server and applying the user's input time to decide how to display it. Alternatively, the input time could be sent to the remote server which can then decide how to display the map data and send this to the mobile device.

The map data in accordance with the invention is not restricted to having just two statuses of operation (e.g. open and closed) but could, instead, have different times associated with different statuses. The statuses which correspond to particular times can be displayed in any convenient way which may include any of those previously mentioned (colour, text, highlighting etc). It is thus not essential for the state of operation to be simply active or inactive or open or closed it could, in one example, correspond to an average number of visitors to a building or facility at a particular time of day, or an average waiting time at a particular time of day which would then allow a user to select an optimum time to visit.

The displayed map or plan could be static or could be arranged selectively or automatically to change the input time—e.g. according to a repeating cycle.

An embodiment of the invention will now be described, by way of example only, with reference to the accompanying drawings in which:

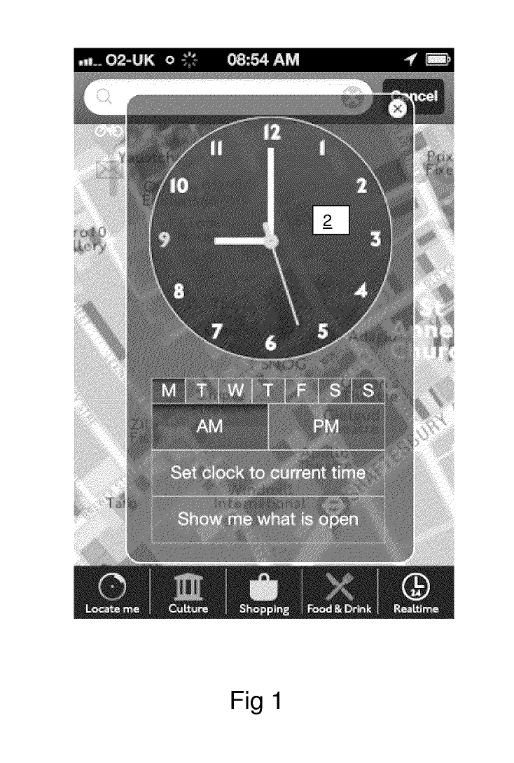

FIG. 1 is representation of a screen display on a device employing an embodiment of the invention showing a possible user interface for setting a time;

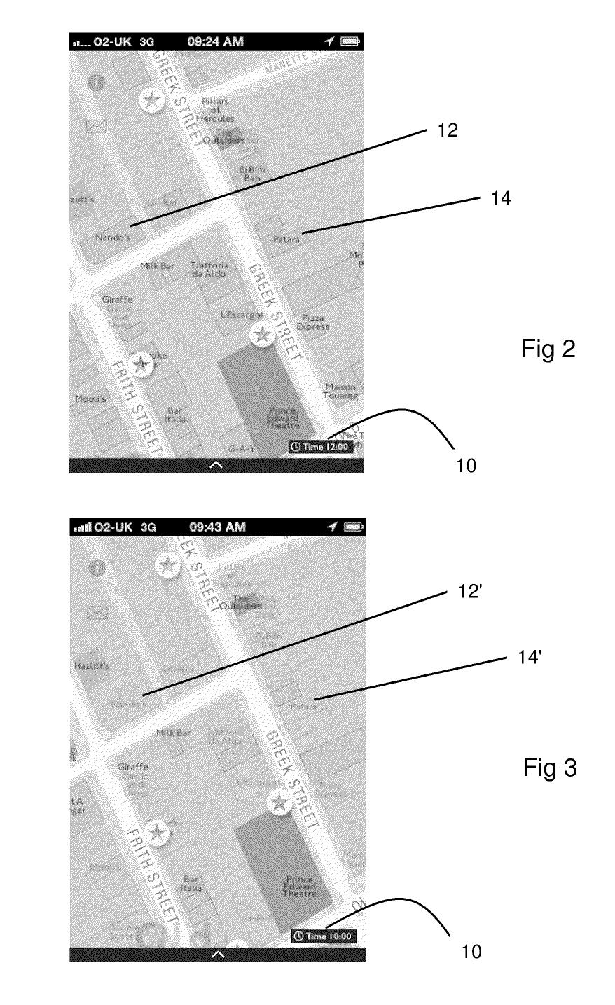

FIG. 2 is screen display showing map data relevant to the time selected;

FIG. 3 is a screen display showing map data relevant to a different selected time;

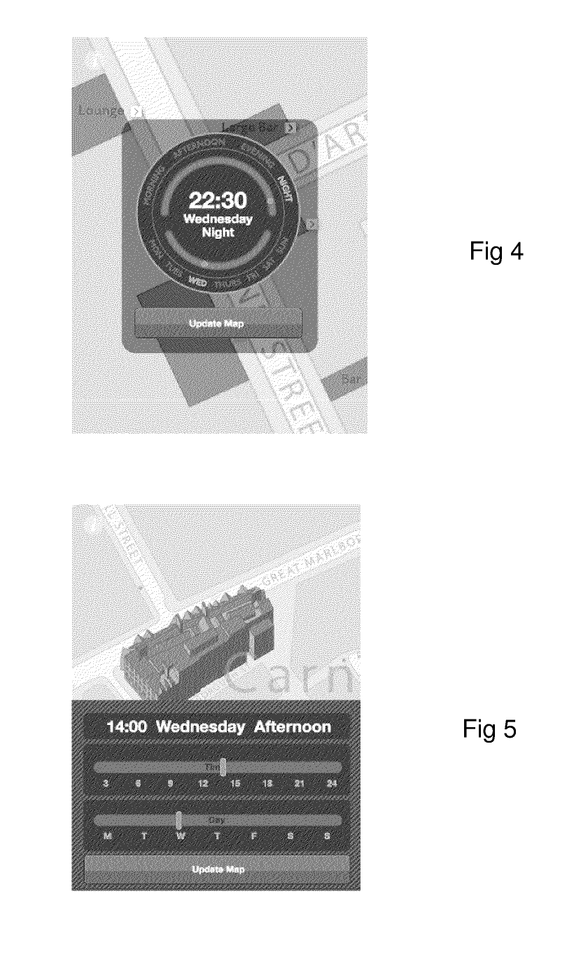

FIG. 4 shows an alternative user interface for entering a required time; and

FIG. 5 shows another alternative. user interface for entering a required time.

The embodiment which will be described herein is implemented as a software application for a mobile computing device such as a smart-phone. However it should be appreciated that the invention can also be implemented on a number of different platforms and in a number of different ways.

In one possible implementation an enhanced version of a basic map application is provided. This may run as a software application on the smart-phone and, as is well known in the art, the software application receives data with the use of an API (Application Protocol Interface). The API-served map tiles are produced with the use of software running on a remote server that applies style-sheets and selections to core geographic and location data stored in a geo-database. The visual appearance and selection is determined by the user's selection along with pre-prepared parameters and is designed to best represent the selection of live data that is required and is at the same time easy to understand.

The software application sends requests to the server which include coordinates of the centre of the map required, zoom level etc. The required coordinates may be derived from a user input or from a location determination function—e.g. based on GPS positioning.

The server software acquires relevant data, which may be contained in a number of types of databases and may include data received from live data-feeds, and as mentioned above it converts this using a pre-determined set of style-sheets and hierarchies into a format which allows the software application to render the required visually pleasing map in SVG (Scalable Vector Graphics) or similar core format and then translates the SVG map data into JPEG or PNG (Portable Network Graphics) tiles and provides this data to the software application. If the map parameters required by the software application change, e.g. because a user has scrolled the map or zoomed out, the software application makes another request to the server for further data to allow it to render the new map.

In the enhancement in accordance with the present invention, the request from the software application to the server includes a time in respect of which the map information is required. The user can specify the required time via a user-interface such as that shown in FIG. 1. This presents a classic clock face, the hands of which the user can manipulate to set a particular time. Buttons below allow either AM or PM and the day of the week to be selected.

The time information is included with the request to the server and the carto-engine uses this to filter the data which it provides back to the software application to show information and statuses relevant to the selected time rather than the actual time.

FIG. 2. shows an example of a resulting map. The time applied to the map is shown in the bottom right-hand of the screen in a time display 10. In the FIG. 2 example the time is assumed to be 12.00 (i.e. noon). Many of the features on the map—e.g. “Nando's” 12 and “Patara” 14 are shown in full colour indicating that they are open at this time.

However FIG. 3 shows another version of the same map in which the user has set a different time as my be seen in the time display 10. In this case some of the map elements e.g. 12′, 14′ are shown greyed out indicating that they are not open at this time.

It will be appreciated therefore that by selecting a time of interest, the user can produce a ‘live’ thematic map, focused on the subject of the live-data available from the feeds and the selection of the user. This may be, but not restricted to: opening-times, locations of crowds, routes of processions or sporting events or the timing and availability of transport connections. The system transforms the raw map data, including time sensitive elements, and creates a ‘live’ ‘thematic’ map. This is in the form of a digital file of some description that is then delivered on demand to the user's device with the use of an online API.

FIGS. 4 and 5 show alternative possible user interfaces for selecting the desired time to apply to the map. Thus FIG. 4 shows a wheel with various rotary sliders and FIG. 5 shows a pair of linear sliders. Of course many other interface designs are possible and these may depend on the data available and the options a user has for changing it.

It will be appreciated of course that the embodiment is merely one example of a possible implementation and that the invention can be used in many other ways. For example it may be displayed on any device that has a data connection to the server. Other user interfaces can be used such as clocks, timelines, or selection buttons. Instead of just times, the user could be presented with more complex options such as e.g. “show me what is open at 10 pm tonight”, “show me the route of the procession at 3 pm” or “show me the best direction to head-to to get home now”.

1. A method of generating a map or plan of a location from a set of map data, wherein at least some of said map data has a time-dependent status associated therewith, the method comprising:
determining an input time from a user input;
displaying said map data according to its associated time-dependent status on the basis of said input time; and
when the input time is changed, changing the map data displayed accordingly.

2. The method of claim 1 wherein the time-dependent status comprises whether a building, service or facility is open or closed.

3. The method of claim 1 wherein map data having a predetermined time-dependent status are omitted from the map.

4. The method of claim 1 wherein the time-dependent status is indicated without omitting map data.

5. The method of claim 1 further comprising displaying the data in a different colour depending on its time-dependent status.

6. The method of claim 1 further comprising labelling the data or omitting a label on the data depending on its time-dependent status.

7. The method of claim 1 wherein the user input comprises a graphical user interface (GUI) element having a plurality of positions corresponding to different times whereby a user can manipulate the GUI element to different positions to select a required time.

8. The method of claim 1 wherein an indication of a time selected by a user is given.

9. The method of claim 1 wherein the generated map is displayed on a screen of a mobile device.

10. An apparatus for generating a map or plan of a location from a set of map data, wherein at least some of said map data has a time-dependent status associated therewith, the apparatus being configured to:
determine an input time from a user input; and
display said map data according to its associated time-dependent status on the basis of said input time;
wherein the apparatus is further configured such that when the input time is changed, the map data displayed is changed accordingly.

11. The apparatus of claim 10 wherein the time-dependent status comprises whether a building, service or facility is open or closed.

12. The apparatus of claim 10 further configured to omit map data having a predetermined time-dependent status from the map.

13. The apparatus of claim 10 further configured to indicate the time-dependent status without omitting map data.

14. The apparatus of claim 10 further configured to display the data in a different colour depending on its time-dependent status.

15. The apparatus of claim 10 further configured to label the data or omit a label on the data depending on its time-dependent status.

16. The apparatus of claim 10 wherein the user input comprises a graphical user interface (GUI) element having a plurality of positions corresponding to different times whereby a user can manipulate the GUI element to different positions to select a required time.

17. The apparatus of claim 10 further configured to give an indication of a time selected by a user.

18. The apparatus of claim 10 further configured to display the generated map on a screen of a mobile device.

19. A non-transitory computer-readable medium having stored thereon instructions executable by a processor to generate a map or plan of a location from a set of map data, wherein at least some of said map data has a time-dependent status associated therewith, the instructions comprising:
determining an input time from a user input; and
displaying said map data according to its associated time-dependent status on the basis of said input time;
wherein when the input time is changed, the map data displayed is changed accordingly.

20. The non-transitory computer-readable medium of claim 19 wherein the time-dependent status comprises whether a building, service or facility is open or closed.

21. The non-transitory computer-readable medium of claim 19 wherein the instructions further comprise omitting map data having a predetermined time-dependent status from the map.

22. The non-transitory computer-readable medium of claim 19 wherein the instructions further comprise indicating the time-dependent status without omitting map data.

23. The non-transitory computer-readable medium claim 19 wherein the instructions further comprise displaying the data in a different colour depending on its time-dependent status.

24. The non-transitory computer-readable medium of claim 19 wherein the instructions further comprise labelling the data or omitting a label on the data depending on its time-dependent status.

25. The non-transitory computer-readable medium of claim 19 wherein the user input comprises a graphical user interface (GUI) element having a plurality of positions corresponding to different times whereby the user can manipulate the GUI element to different positions to select the required time.

26. The non-transitory computer-readable medium of claim 19 wherein the instructions further comprise giving an indication of a time selected by a user.

27. The non-transitory computer-readable medium of claim 19 wherein the instructions further comprise displaying the generated map on a screen of a mobile device.
